(19) United States
(12) Patent Application Publication
(10) Pub. No.: US 2013/0345990 A1
(43) Pub. Date: Dec. 26, 2013

(54) TOOL FOR OPTIMIZING CHLORINATED-SOLVENT BIOREMEDIATION THROUGH INTEGRATION OF CHEMICAL AND MOLECULAR DATA WITH ELECTRON AND ALKALINITY BALANCES

(71) Applicants: Michal Ziv-El, Tempe, AZ (US); Rosa Krajmalnik-Brown, Chandler, AZ (US); Bruce E. Rittmann, Tempe, AZ (US); Sudeep Popat, Chandler, AZ (US)

(72) Inventors: Michal Ziv-El, Tempe, AZ (US); Rosa Krajmalnik-Brown, Chandler, AZ (US); Bruce E. Rittmann, Tempe, AZ (US); Sudeep Popat, Chandler, AZ (US)

(73) Assignees: Arizona State University, Scottsdale, AZ (US); Arizona Board of Regents, A body corporate of the State of Arizona, Acting for and on behalf of

(21) Appl. No.: 13/918,779

(22) Filed: Jun. 14, 2013

Related U.S. Application Data
(60) Provisional application No. 61/660,166, filed on Jun. 15, 2012.

(51) Int. Cl. G01N 27/26

(52) U.S. Cl. CPC G01N 27/26
USPC 702/30

(57) ABSTRACT

A prediction and assessment tool for bioremediation performance based on a comprehensive understanding of the link between chemical flow and microbial community interactions includes linking molecular microbial ecology data with electron and alkalinity balances to make it possible to understand dechlorinating microbial communities and their metabolic processes. The interactions of biological processes and site mineralogy result in changes to alkalinity and pH that can lead to incomplete reductive dechlorination resulting from suboptimal pH. Understanding these interactions allows for strategies to predict expected bioremediation outcomes and/or to mitigate incomplete reductive dechlorination.

### CROSS-REFERENCE TO RELATED APPLICATIONS

This application claims priority to, and incorporates by reference, co-pending U.S. Provisional Patent Application Ser. No. 61/660,166, entitled, “TOOL FOR OPTIMIZING CHLORINATED-SOLVENT BIOREMEDIATION THROUGH INTEGRATION OF CHEMICAL AND MOLECULAR DATA WITH ELECTRON AND ALKALINITY BALANCES” to Ziv-El, et al. which was filed on Jun. 15, 2012.

### STATEMENT REGARDING US FEDERALLY SPONSORED RESEARCH OR DEVELOPMENT

This invention was partially made with Government support under Career Award 1053939 to Rosa Krajmalnik-Brown awarded by the National Science Foundation. The Government has certain rights in this invention.

### TECHNICAL FIELD

The present invention relates to a method and tool for optimizing chlorinated-solvent bioremediation through integration of chemical and molecular data with electron and alkalinity balances.

### BACKGROUND

Trichloroethene (TCE) is a common groundwater contaminant. Chlororespiring bacteria use chlorinated compounds (such as TCE) as electron acceptors in their energy metabolism. These bacteria belong to four phylogenetic groups: low G+C Gram-positives, δ-Proteobacteria, ε-Proteobacteria, and green non-sulfur bacteria (or Chloroflexi). In most cases, the end product of the dechlorination reactions is cis-dichloroethene (DCE) or vinyl chloride (VC), which retains serious toxicity. However, members of the genus Dehalococcoides, which are part of the green non-sulfur bacteria, can completely reduce DCE and VC to non-toxic ethene (Maymo-Gatell et al. 1997; Cupples et al. 2003; He et al. 2003; Müller et al. 2004; He et al. 2005; Sung et al. 2006b), and laboratory (Duhamel et al. 2002; Cupples et al. 2003; He et al. 2003) and field studies (Hendrickson et al. 2002; Major et al. 2002; Lendvay et al. 2003; Macbeth et al. 2004) have demonstrated a link between the presence of Dehalococcoides and complete dechlorination of TCE to ethene. Therefore, successful reductive dechlorination must involve Dehalococcoides.

Refer now to FIG. 1, where the microbial community involved in reductive dechlorination is shown. Potential electron (e⁻) donors are in solid boxes, electron acceptors are in dashed boxes, solid lines represent flow of electrons, and dashed lines represent flow of growth factors. Four processes, illustrated in FIG. 1, are essential in order for microbial communities to carry out reductive dechlorination of chlorinated ethenes. First is reductive dechlorination by Dehalococcoides sp. and other dechlorinators. Second is provision of H₂, the obligate e⁻ donor for Dehalococcoides (Distefano et al. 1992; Maymo-Gatell et al. 1995; Maymo-Gatell et al. 1997; He et al. 2003; He et al. 2005). The most common approach is to ferment organic substrates to form H₂ (Smidt and de Vos 2004). Third is provision of acetate, since acetate is the obligate C-source for Dehalococcoides (Tang et al. 2009) and a possible e⁻ donor and C-source for other dechlorinators (Sung et al. 2006a; He et al. 2007; Maphosa et al. 2010). Acetate could be provided from: (1) fermentation of the organic electron donor, (2) autotrophic reactions by homoacetogens, (3) biomass decay processes by a wide group of organisms that can consume complex organics, or (4) direct delivery. The fourth requirement are growth factors, including the vitamin B₁₂ cofactor necessary for reductive dehalogenase enzymes of Dehalococcoides (He et al. 2007), which are presumably formed during the acetate-producing processes (Maymo-Gatell et al. 1995).

Tracking the distribution of electrons to these and to competing processes is an effective strategy for understanding the dominant functions taking place in microbial communities carrying out reductive dechlorination (Aulenta et al. 2002; Aulenta et al. 2005; Azizian et al. 2010). At field sites, however, operators are able to measure concentrations of typical electron acceptors, remaining electron donors, and products of fermentation, but often have difficulty interpreting the measured results because of lack of knowledge on how to integrate the data with microbial processes.

Carrying out some molecular-biology-based analyses (molecular techniques) has also become commonplace at contaminated sites. Molecular techniques for tracking reductive dechlorination are abundant, and these are summarized in a review article by Maphosa et al. (2010). The most common molecular techniques used at contaminated sites are the polymerase chain reaction (PCR) (Lendvay et al. 2003), quantitative PCR (qPCR) (Ritalahti et al. 2006), and denaturing gradient gel electrophoresis (DGGE), with the prime focus usually being detection and quantification of Dehalococcoides (Air Force Center for Environmental Excellence 2004). As with the chemical data, here too, operators and consultants often have difficulty interpreting the implications of these analyses.

Various lab-scale studies have used molecular-biology techniques to correlate reductive dechlorination products (i.e., chlorinated ethenes and ethene) with the growth of Dehalococcoides and other dechlorinators (Duhamel and Edwards 2007; Vainberg et al. 2009). However, these techniques, which provide information on the microbial community structure, have not clearly demonstrated trends between electron flow and the relative abundance of dechlorinators and the other microorganisms (Richardson et al. 2002; Duhamel and Edwards 2006; Parameswaran et al. 2010). As disclosed herein in an advance over known methods, electron balances provide the vital link between performance and microbial community structure by allowing for linkage between the predicted community structures based on electron flow with that obtained via molecular techniques.

This electron-balance approach for understanding complex microbial communities has been applied in our laboratory for other systems. For example, Lee et al. combined these complementary techniques to understand the pathways and microorganisms involved in fermentative bio-hydrogen production (Lee et al. 2009). Parameswaran et al. applied them to microbial electrochemical cells to reveal syntrophic and competitive interactions in the microbial community of the anode (Parameswaran et al. 2009).

Biological conversion of TCE and other electron acceptors present in groundwater also can alter the pH, perhaps placing it outside the optimum range for Dehalococcoides, thus resulting in slow and incomplete dechlorination (McCarty et al. 2007). Robinson et al. (2009) developed a tool to predict the groundwater pH resulting from reductive dechlorination of source zones of DNAPLs; the tool also computes the buffer requirement, in the form of bicarbonate, to offset acid production and achieve a near-neutral pH. In short, reductive dechlorination is an acid-producing process. For each mole of TCE that is reduced completely to ethene, three moles of hydrochloric acid are produced. Similarly, fermentation reactions of typically used electron donors produce organic acids, which, in combination with the hydrochloric acid, reduce the groundwater pH. The acid produced by these processes reacts with the bicarbonate present in the groundwater to lead to formation of CO₂. If this CO₂ cannot readily escape through volatilization, groundwater pH decreases further. On the other hand, biological processes that result in reduction of CO₂ and other commonly found electron acceptors, such as nitrate and sulfate, lead to production of alkalinity, which counters the production of acid. In addition to alkalinity produced by biological reactions, groundwater contains natural alkalinity resulting from dissolution of minerals. All sources and sinks of alkalinity need to be considered when evaluating the effect of various processes on groundwater pH. As far as we know, the tool developed by Robinson et al. (2009) has not been tested via laboratory experiments or field tests. In an advance over known processes, we have conceptually merged a tool similar to that described by Robinson et al. with our electron balances and expand the scope of the reactions.

### BRIEF SUMMARY OF THE DISCLOSURE

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A prediction and assessment tool for bioremediation performance based on a comprehensive understanding of the link between electron flow, alkalinity, and microbial community interactions is disclosed. The following underlies the tool: Cross-correlating molecular microbial ecology data with electron and alkalinity balances makes it possible to understand dechlorinating microbial communities and their metabolic processes. Applying this understanding maximizes the accuracy of performance evaluation and prediction of a bioremediation process. The interactions of biological processes and site mineralogy result in changes to alkalinity and pH that can lead to incomplete reductive dechlorination resulting from suboptimal pH. In addition, too much flow of electrons to processes other than reductive dechlorination (e.g. to acetate) may result in incomplete reduction of TCE, wasted electron donor, and biomass clogging. Understanding these interactions allows for strategies to mitigate incomplete reductive dechlorination.

In one aspect, a computerized method for implementing a prediction and assessment method for bioremediation performance is presented. A computer processor accepts input data, including chemical and microbial data. The processor operates to integrate the chemical data and microbial data using electron and alkalinity balances that are based on microorganism-specific parameters, including experimentally determined parameters of the dominant microbial groups. The microorganism-specific parameters include a plurality of fractions of donor electrons that each microorganism sends to biomass synthesis (fₛ°), a plurality of corresponding true yields (Y) expressed in electron equivalents, and a plurality of microorganism cell volumes. The processor is used to calculate the relative abundance of each microorganism group.

In another example, the chemical data inputs are selected from the group consisting of electron acceptors at a contaminated site and the fermentable substrate to be used as the electron donor, the end or intermediate products of the reactions, and combinations thereof.

In another example, the microbial data comprises microorganisms that are expected to be involved in the flow of electron donor to reductive dechlorination, reduction of the other electron acceptors, and fermentation.

In another example, chemical inputs, defined as inputs of type 1, are the electron acceptors at a contaminated site and the fermentable substrate to be used as the electron donor, wherein the chemical inputs of type 1 are applicable for use of the model as a predictive tool.

In yet another example, chemical inputs, defined as inputs of type 2, are the end (or intermediate) products of the reactions, as would be the case when the model is to be used for assessment of the bioremediation processes that already occurred at a site.

In yet another example, the chemical inputs comprise a combination of type 1 and type 2 chemical inputs.

In yet another example, a third type of input comprises dominant microorganisms that are expected to be involved in the flow of electron donor to reductive dechlorination, reduction of the other electron acceptors, and fermentation.

In another example, the relative abundance of each microorganism group, i, is computed assuming cells to be N % dry weight by mass, with dry weight M % organic by mass:

$${microorganism}_{i} [ \frac{cell copies}{L} ] = \frac{\begin{matrix}{biomass}_{i} [ \frac{{e}^{-} eq .}{L} ] \times \\ {Yield}_{i} [ \frac{g dry org . bio .}{{e}^{-} eq .} ] \times {10}^{12} [ \frac{{µm}^{3}}{g bio .} ]\end{matrix}}{\begin{matrix}{f}_{s , i}^{0} \times N \% [ dry cell fraction ] \times \\ M \% [ org . cell fraction ] \times volume {cell}_{i} [ {µm}^{3} ]\end{matrix}}$$

In another example, an output processor generates an output spreadsheet including experimental inputs, a first table of microorganism features, a second table of electron-balance components based on electron flow, and a set of output tables calculated from the first and second tables.

In another example, the first table comprises a set of volume measurements, a set of yield values, and a set of fractions of donor electrons that each microorganism sends to biomass synthesis (fₛ°).

### BRIEF DESCRIPTION OF THE DRAWINGS

While the novel features of the invention are set forth with particularity in the appended claims, the invention, both as to organization and content, will be better understood and appreciated, along with other objects and features thereof, from the following detailed description taken in conjunction with the drawings, in which:

FIG. 1 shows the microbial community involved in reductive dechlorination.

FIG. 2 schematically shows factors influencing solution acidity and alkalinity, as found in the prior art.

FIG. 3 schematically shows an example of one embodiment of a model-based tool that uses electron and alkalinity balances to predict the microbial community structure, function, and groundwater pH.

FIG. 4A schematically shows an example of a schematic of steps in the electron balance analysis,

FIG. 4B shows an example of a computer screenshot of a spreadsheet derived from a software program that allows one to enter numerical values or data into the rows or columns of a spreadsheet, and to use these numerical entries for such things as calculations, graphs, and statistical analysis.

FIG. 5 schematically shows an example of microbial electron flow for the microbial community of DehaloR̂2.

FIG. 6A and FIG. 6B, respectively, show an example (A) pH as a function of amended lactate concentration, and (B) additional buffer requirement to maintain pH 7 as a function of amended lactate concentration, for hypothetical Cases 1-3 presented herein.

In the drawings, identical reference numbers identify similar elements or components. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

### DETAILED DESCRIPTION OF THE PREFERRED EMBODIMENTS

The following disclosure describes several embodiments of a prediction and assessment tool for bioremediation performance based on a comprehensive understanding of the link between chemical flow and microbial community interactions. Several features of methods and systems in accordance with example embodiments are set forth and described in the Figures. It will be appreciated that methods and systems in accordance with other example embodiments can include additional procedures or features different than those shown in the Figures. Example embodiments are described herein with respect to analysis of environmental conditions. However, it will be understood that these examples are for the purpose of illustrating the principles and that the invention is not so limited. Additionally, methods and systems in accordance with several example embodiments may not include all of the features shown in the Figures.

Unless the context requires otherwise, throughout the specification and claims which follow, the word “comprise” and variations thereof, such as, “comprises” and “comprising” are to be construed in an open, inclusive sense that is as “including, but not limited to.”

Reference throughout this specification to “one example” or “an example embodiment,” “one embodiment,” “an embodiment,” or combinations and/or variations of these terms means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

### DEFINITIONS

Generally, as used herein, the following terms have the following meanings when used within the context of contaminant sample collection in aquatic or saturated-sediment environments:

DehaloR̂2 as used herein is an anaerobic microbial consortium that performs rapid dechlorination of TCE to ethene.

“Obtaining” is understood herein as manufacturing, purchasing, or otherwise coming into possession of.

As used herein, “plurality” is understood to mean more than one. For example, a plurality refers to at least two, three, four, five, ten, 25, 50, 75, 100, or more.

As used in this specification, the terms “processor” and “computer processor” encompass a personal computer, a tablet computer, a smart phone, a microcontroller, a microprocessor, a field programmable object array (FPOA), a digital signal processor (DSP), an application-specific integrated circuit (ASIC), a field programmable gate array (FPGA), a programmable logic array (PLA), or any other digital processing engine, device or equivalent capable of executing software code including related memory devices, transmission devices, pointing devices, input/output devices, displays and equivalents.

Recently, a paper by Ziv-El et al. (2012), where the authors included the inventors here, disclosed application of an electron-balance approach in a study for reductive-dechlorination communities in order to assess how stress from chlorinated ethenes can alter the microbial community abundance and structure. This study is further described below, and data are provided. In brief, we demonstrated that using electron balances to couple chemical data with high-throughput DNA sequencing (pyrosequencing) and qPCR predicted trends in the microbially driven processes and the microbial community structure. The teachings of (Ziv-El et al. 2012) are incorporated in their entirety by this reference.

The 2012 Ziv-El et al. paper focused on TCE as the electron acceptor, but many oxidized compounds are found in groundwater from naturally present soil mineralogy, microbial activity, and anthropogenic contaminants. The list includes bicarbonate, nitrate, sulfate, iron, manganese, selenate, chromate, and halogenated compounds other than chlorinated ethenes. The microorganisms that reduce these other compounds are significant in the context of reductive dechlorination for a number of reasons that have been well documented. First, they compete with dechlorinators for substrate (e.g., H₂ and acetate). Second, they or their products may inhibit reductive dechlorination (e.g., sulfide, chromium). Third, they may produce undesired end products (e.g. methane, sulfide) or downstream become biochemical oxygen demand in the water (e.g., acetate).

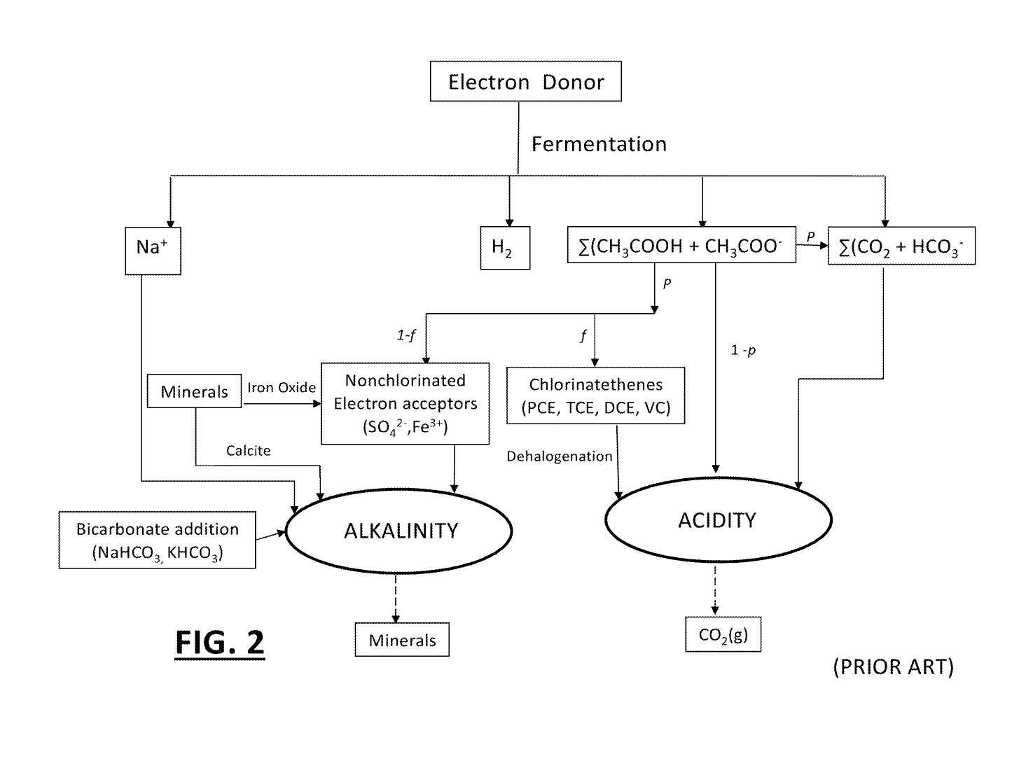

The biological conversion of these electron acceptors also can alter the pH, perhaps placing it outside of the optimum range for Dehalococcoides, thus resulting in slow and incomplete dechlorination (McCarty et al. 2007). In a 2009 publication (Robinson et al. 2009), the authors there developed a tool to predict the groundwater pH resulting from reductive dechlorination of source zones of DNAPLs; the tool also computes the buffer requirement, in the form of bicarbonate, to offset acid production and achieve a near-neutral pH. The fundamentals behind the alkalinity balance used in this tool are shown in FIG. 2.

In short, reductive dechlorination is an acid-producing process. For each mole of TCE that is reduced completely to ethene, three moles of hydrochloric acid are produced. Similarly, fermentation reactions of typically used electron donors produce organic acids, which, in combination with the hydrochloric acid, reduce the groundwater pH. The acid produced by these processes reacts with the bicarbonate present in the groundwater to lead to formation of CO₂. If this CO₂ cannot readily escape through volatilization, groundwater pH decreases further.

On the other hand, biological processes that result in reduction of CO₂ and other commonly found electron acceptors, such as nitrate and sulfate, lead to production of alkalinity, which counters the production of acid. In addition to alkalinity produced by biological reactions, groundwater contains natural alkalinity resulting from dissolution of minerals. All sources and sinks of alkalinity need to be considered when evaluating the effect of various processes on groundwater pH.

As far as we know, the tool developed by Robinson et al. (2009) has not been tested via laboratory experiments or field tests. In the example embodiments herein, a tool similar to that described by Robinson is merged with our new model using electron balances, and the scope of the reactions is expanded. The result is a practical tool that can be used to predict potential TCE bioremediation and to evaluate TCE bioremediation progress at contaminated sites.

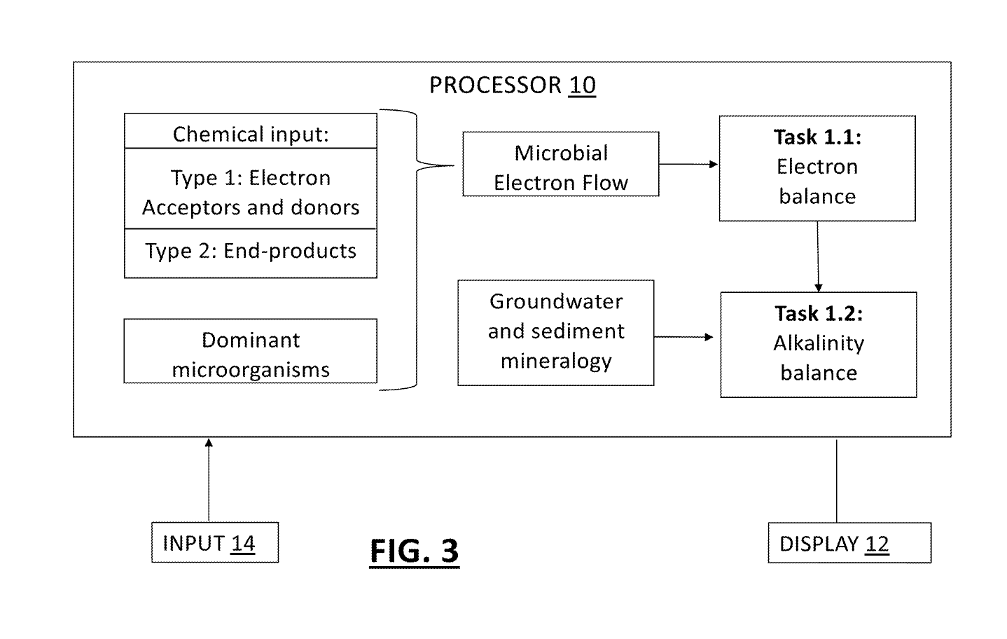

Now refer to FIG. 3, an example of one embodiment of a model-based tool that uses electron and alkalinity balances to predict the microbial community structure, function, and groundwater pH is schematically shown including a method for electron-balance analysis to assess electron distribution and predict microbial community structure based on measurable changes in electron donors and acceptors. The method is advantageously implemented using a software program, for example, in a processor 10 having a display 12 and input devices 14. The processor 10 may comprise a computer processor, such as a personal computer or the equivalent. In a useful embodiment, a spreadsheet software program is employed, such as an Excel® spreadsheet program available from Microsoft, Inc., of Redmond, Wash.

The electron-balance analysis is based on the major microbial processes at pseudo steady state, defined by stability in the microbial functions and the relative abundance of the major microbial groups. Two pieces of input data are required: (1) chemical and (2) microbial. The chemical inputs are of two types, depending on whether the model is to be used as a predictive tool or an assessment tool. Chemical inputs of type 1 are the electron acceptors at a contaminated site and the fermentable substrate to be used as the electron donor; this input is applicable for use of the model as a predictive tool. Chemical inputs of type 2 are the end (or intermediate) products of the reactions, as would be the case when the model is to be used for assessment of the bioremediation processes that already occurred at a site. It is also possible to have a combination of these two chemical input types if remediation of the site is in progress. The second type of input are the dominant microorganisms that are expected to be involved in the flow of electron donor to reductive dechlorination, reduction of the other electron acceptors, and fermentation. We refer to the conceptual diagram of this state of the electrons and the involved microbial groups as the microbial electron flow.

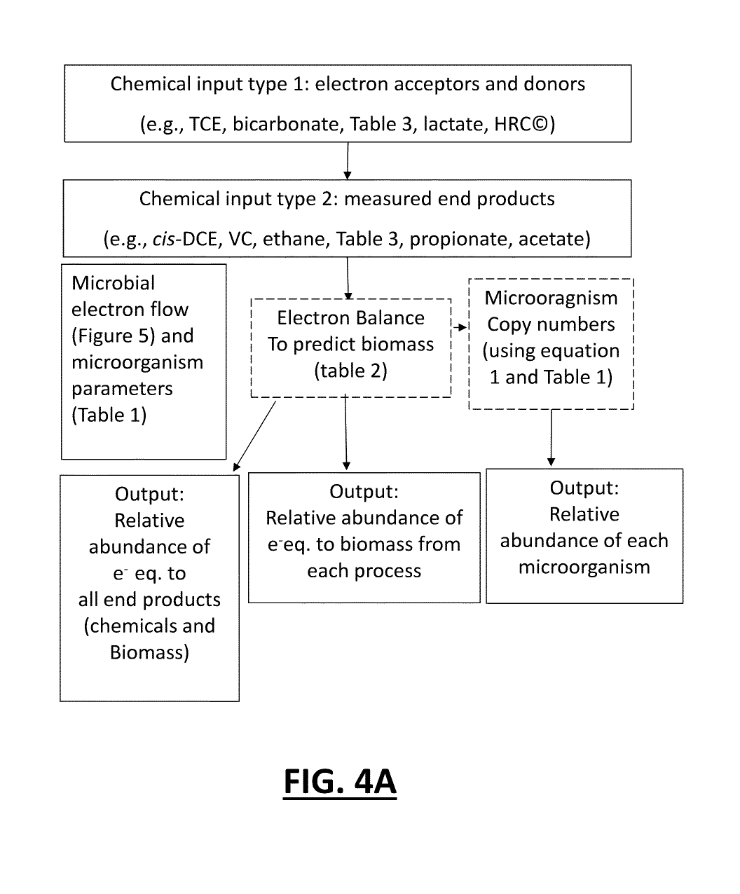

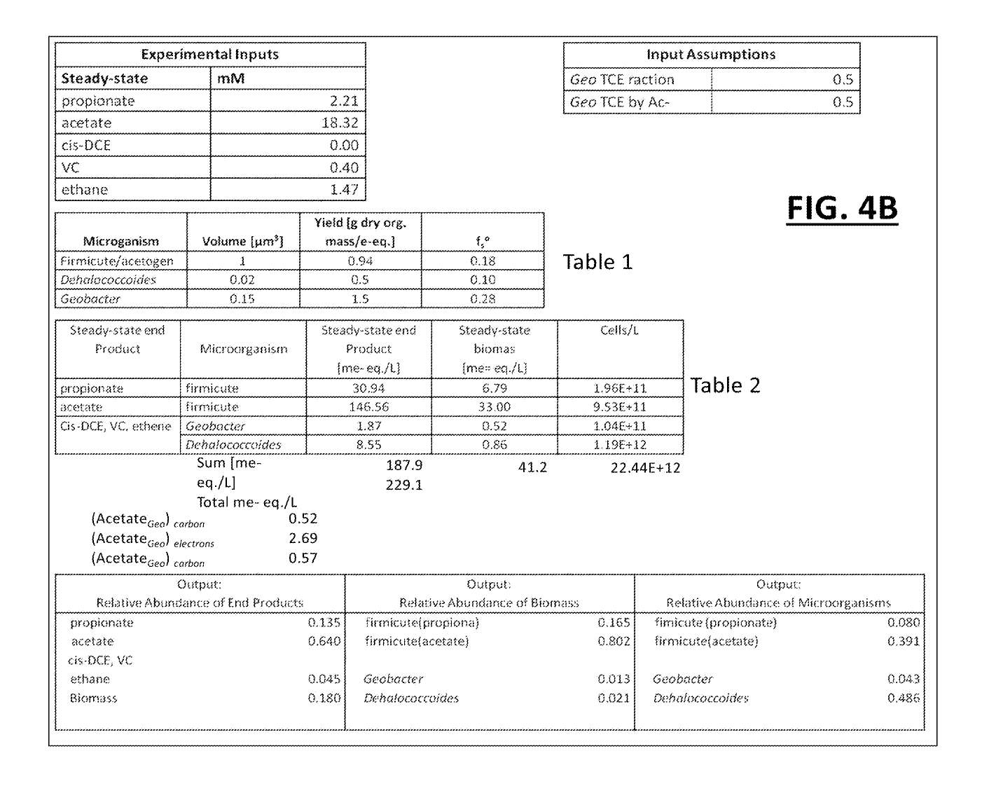

Refer now to FIG. 4A, a schematic example of how the electron balance analysis works and a preliminary run is presented. The chemical and microbial inputs are integrated with electron balances using microorganism-synthesis equations. A computer screenshot of a corresponding software spreadsheet, for an example described below, is shown in FIG. 4B. Three experimentally determined parameters of these dominant microbial groups are required (as shown in FIG. 4B): the fractions of donor electrons that each microorganism sends to biomass synthesis (fₛ°), the corresponding true yields (Y) expressed in electron equivalents, and the microorganism cell volumes. This approach allows estimating and validating the distribution of electron donor to reductive dechlorination, reduction of other electron acceptors, fermentation, and growth of the microorganisms participating in these reactions. The units for all three are (e⁻ meq/L), electron milliequivalents per liter. (AcetateGeo)_{carbon} is the acetate used by Geobacter as a carbon source, (AcetateGeo)_{electrons} is the acetate used by Geobacter as an electron donor source, and (AcetateDhc)_{carbon} is the acetate used by Dehalococcoides as a carbon source. The values for (AcetateGeo)_{carbon}, (AcetateGeo)_{electrons}, and (AcetateDhc)_{carbon} are incorporated into the steady-state biomass values resulting from acetate, cell D16 in the Excel spreadsheet. The equations for all three are in Table 2 of the disclosure. The equations for the first two are in footnote b and the last is in footnote c.

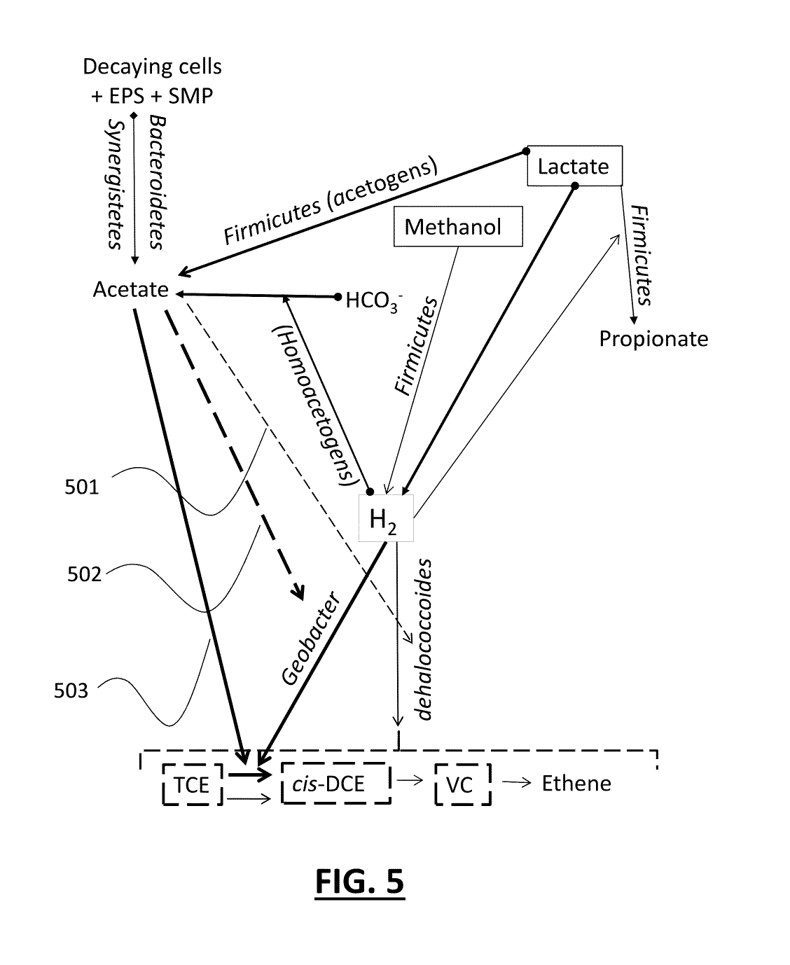

As an illustration, we describe the development of the electron-balance analysis based on the study in the 2012 paper by Ziv-El et al. First, the authors describe the input data that correspond to the model required inputs in FIGS. 3, 4A, and 4B. The initial electron acceptors are TCE and bicarbonate, and the electron donor fermentable substrates are lactate and methanol. Chemical inputs to the model are the end products, input type 2. These are propionate, acetate, TCE, cis-DOE, VC, and ethene. The microbial inputs rely on our understanding of the mixed-microbial consortium used as the inoculum, DehaloR̂2 (Ziv-El et al. 2011). The major microbial groups are Dehalococcoides, Geobacter (a possible dechlorinating genus within the sub-phylum Deltaproteobacteria), and Firmicutes (a phylum containing many bacteria that carry out fermentation reactions). The microbial electron flow for this community is shown in FIG. 5. The microbial parameters of these dominant microorganisms are listed in Table 1. The electron balance for this example is detailed in Table 2.

FIG. 5 schematically shows an example of microbial electron flow for DehaloR̂2. Initial electron donors and acceptor are in boxes. Products are in standard type, each distinct microbial group is in italics, dashed-line 501 represents use of C only, dashed line 502 represents the use of C and electrons and solid line 503 represent electrons or electrons combined with C.

Embedded in the microbial electron flow are parameters specific to the electron donors, acceptors, and microbial community. In this example, one such parameter is the fraction of TCE to cis-DCE reduction carried out by a Geobacter, the dechlorinating bacteria in that culture other than Dehalococcoides. This parameter is termed “% by Geo.” The other parameter of this type in the example is the fraction of the TCE to cis-DCE reduction by Geobacter that used acetate as the electron donor; this is termed “% Geo e⁻ by Ac⁻.” The distribution of fermentation products from the electron donor may also require parameterization. Using lactate as an example, the ratio of the end products acetate and propionate depends strongly on the present electron acceptors and the microbial community. For example, Seeliger et al. found that Clostridia, which generally ferment lactate to acetate and propionate in a molar ratio of 1:2, obtain a higher metabolic energy when they partner with H₂ scavengers and ferment lactate to acetate only (Seeliger et al. 2002). In the study in Ziv-El et al., the potential H₂ scavengers were methanogens, Dehalococcoides, and the homoacetogenic genera Acetobacterium.

The relative abundance of each microorganism group, i, is then computed assuming cells to be 20% dry weight by mass, with dry weight 90% organic by mass:

$${microorganism}_{i} [ \frac{cell copies}{L} ] = \frac{\begin{matrix}{biomass}_{i} [ \frac{{e}^{-} eq .}{L} ] \times \\ {Yield}_{i} [ \frac{g dry org . bio .}{{e}^{-} eq .} ] \times {10}^{12} [ \frac{{µm}^{3}}{g bio .} ]\end{matrix}}{\begin{matrix}{f}_{s , i}^{0} \times 0.2 [ dry cell fraction ] \times \\ 0.9 [ org . cell fraction ] \times volume {cell}_{i} [ {µm}^{3} ]\end{matrix}} \qquad ( 1 )$$

TABLE 1
Microorganism-specific parameters used in the electron-balance analysis.

| | Volume | Yield | |
|---|---|---|---|
| Microorganism | [μm³] | [g dry org. mass/e− eq.] | fₛ⁰ |
| Firmicutes | 1^{a} | 0.94^{b} | 0.18^{c} |
| Dehalococcoides | 0.02^{d} | 0.5^{d} | 0.10^{e} |
| Geobacter | 0.15^{f} | 1.4^{d} | 0.28^{e} |

Notes for Table 1
^{a}Madigan and Martinko (2006).
^{b}Using the yield from Rittmann and McCarty (Rittmann and McCarty 2001),
Table 3.1, the units were converted using Y = (0.13 [g VSS/g BODL])* (8 [g BODL/e− eq.])* (0.9 [g org. matter/g VSS]).
^{c}Rittmann and McCarty (2001).
^{d}Duhamel and Edwards (2007).
^{e}fs0 = Y × (20 e− eq./mol VSS)/(113 g VSS/mol VSS)/(0.9 g org. matter/g VSSb).
^{f}Sung et al. (2006a).

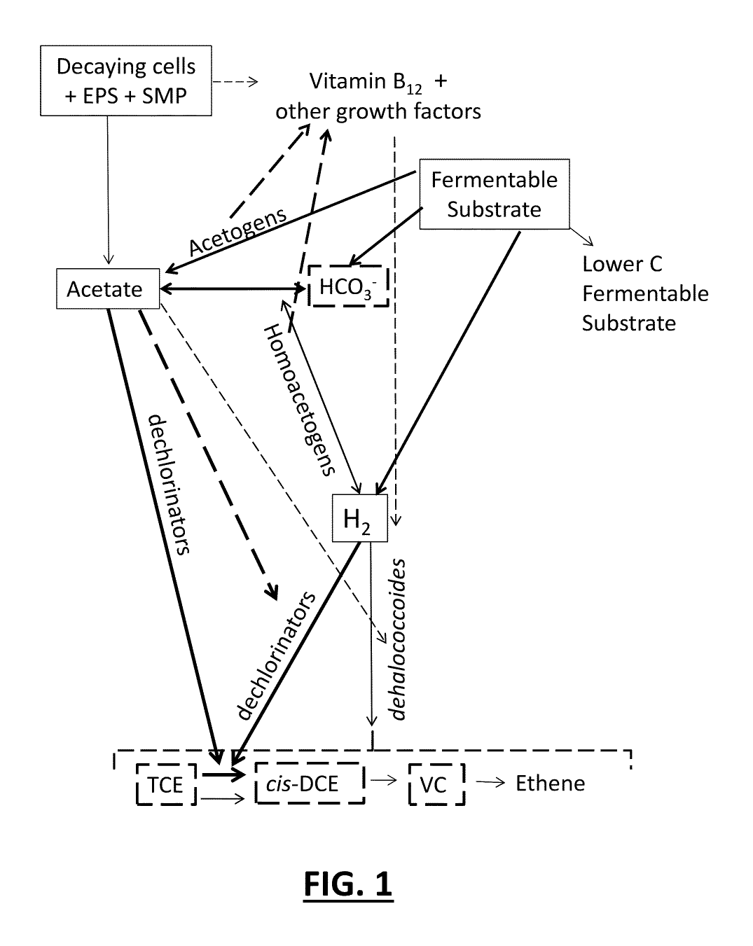

TABLE 2
Electron-balanced components based on electron flow (FIG. 1) and fₛ⁰
values (Table 2).

| steady-state end product [mM] | microorgan- ism | $\frac{{me}^{-} eq .}{mmol}$ | steady-state end $product ( \frac{{me}^{-} eq .}{L} )$ | steady-state biomass^{a} $( \frac{{me}^{-} eq .}{L} )$ |
|---|---|---|---|---|
| [propionate] | fermenter | 14 | [propionate] × 14 | $\frac{( end product )}{1 - {f}_{s , fer}^{0}} \times {f}_{s , fer}^{0}$ |
| [acetate] | fermenter | 8 | [Ac⁻] × 8 | $\frac{( end product ) + {( {Ac}_{Geo}^{-} )}^{b} + {( {Ac}_{Dhc}^{-} )}^{c}}{1 - {f}_{s , fer}^{0}} \times {f}_{s , fer}^{0}$ |
| [cis-DCE], | Geobacter | 2 | ([cis − DCE] + [VC] + | (end product) × f_{s,Geo}⁰ |
| [VC], [ethene] | | | [ethene]) × 2 × (% by Geo)^{d} | |
| | Dhc. | 2, 4, | ([cis−DCE] × 2 + [VC] 4 + | (end product) × f_{s,Dhc}⁰ |
| | | or 6 | [ethene] × 6) − ([cis−DCE] + | |
| | | | [VC] + [ethene]) × 2 × (% by Geo)^{c} | |

Notes For Table 2
^{a}fₛ⁰ values are in Table 1.
^{b}(Ac_{Geo}⁻) is the acetate used by Geobacter either as a carbon source,
${( {Ac}_{Geo}^{-} )}_{carbon} , or as an {e}^{-} donor , {( {Ac}_{Geo}^{-} )}_{electrons} \cdot {( {Ac}_{Geo}^{-} )}_{carbon} = {( biomass )}_{Geo} \times ( \frac{mmol biomass}{20 {me}^{-} eq .} ) \times ( \frac{5 mmoles C}{mmol biomass} ) \times ( \frac{mmoles {Ac}^{-}}{2 mmoles C} ) \times ( \frac{8 {me}^{-} eq .}{mmoles {Ac}^{-}} ) , where biomass was assumed to be {C}_{5} {H}_{7} {O}_{2} N , and N was assumed to be from {NH}_{4}^{+} so there were 20 {me}^{-} eq . \text{/} mmol biomass ( Rittmann and McCarthy 2001 ) .$ ${( {Ac}_{Geo}^{-} )}_{electrons} = {( end product )}_{Geo} \times ( \frac{mole cis - DCE}{2 {e}^{-} eq .} ) \times ( \frac{8 {e}^{-} eq .}{mole {Ac}^{-}} ) \times ( 1 - {f}_{s , Geo}^{0} ) ( \% {e}^{-} by {Ac}^{-} ) , where ( \% {e}^{-} by {Ac}^{-} ) was the assumed fraction of electron donor from acetate ; a sensitivity analysis was carried out on this parameter as described in the text .$ ^{c}(Ac_{Dhc}⁻) is the acetate used by Dehalococcoides as the carbon source. Assume biomass is C₅H₇O₂N and N is from NH₄⁺ so there are 20 me⁻ eq./mmol biomass (Rittman and McCarthy 2001), and 67% of carbon source is from acetate (Tang et al. 2009).
$( {Ac}_{Dhc}^{-} ) = {( biomass )}_{Dhc} \times ( \frac{mmol biomass}{20 {me}^{-} eq .} ) \times ( \frac{5 mmoles C}{mmol biomass} ) \times ( 0.67 ) \times ( \frac{mmoles {Ac}^{-}}{2 mmoles C} ) \times ( \frac{8 {me}^{-} eq .}{mmoles {Ac}^{-}} )$ ^{d}(% by Geo) was the assumed fraction of TCE to cis-DCE reduction carried out by Geobacter.

Possible fermentation and hydrogen-consuming processes for the example presented here and for an expanded electron balance are summarized in Table 3.

TABLE 3
Electron donor and acceptor reactions that will be considered
in the electron and alkalinity balances.

| | | Net | Net |
|---|---|---|---|
| | e⁻ | acid- | alkalin- |
| | eq./ | icity/ | ity/ |
| | mol* | mol** | mol** |
| Fermentation reactions: | | | |
| (1) Lactate⁻ + 2H₂O → | 12 | +1 | 0 |
| Acetate⁻ + 2H₂ + HCO₃⁻ + H⁺ | | | |
| (2) Propionate⁻ + 3H₂O → | 14 | +1 | 0 |
| Acetate⁻ + 3H₂ + HCO₃⁻ + H⁺ | | | |
| (3) Acetate⁻ + H₂O → CH₄ + HCO₃⁻ | 8 | 0 | +1 |
| (4) Acetate⁻ + 4H₂O →4H₂ + 2HCO₃⁻ + H⁺ | 8 | +1 | +1 |
| Hydrogen-consuming reactions | | | |
| (electron acceptors): | | | |
| (5) C₂HCl₃ + H₂ → C₂H₂Cl₂ + H⁺ + Cl⁻ | 2 | +1 | 0 |
| (6) C₂H₂Cl₂ + H₂ → C₂H₃Cl + H⁺ + Cl⁻ | 2 | +1 | 0 |
| (7) C₂H₃Cl + H₂ → C₂H₄ + H⁺ + Cl⁻ | 2 | +1 | 0 |
| (8) HCO₃⁻ + 4H₂ + H⁺ → CH₄ + 2H₂O | 8 | −0.25 | 0 |
| (9) HCO₃⁻ + 2H₂ + 0.5H⁺ → | 4 | −0.25 | −0.5 |
| ½ C₂H₃O₂⁻ + 2H₂O | | | |
| (10) NO₃⁻ + 2½ H₂ + H⁺ → ½ N₂ + 3H₂O | 5 | −0.4 | +0.4 |
| (11) SO₄²⁻ + 4H₂ + H⁺ → HS⁻ + 4H₂O | 8 | −0.25 | +0.25 |
| (12) Fe(OH)₃ + ½ H₂ → Fe²⁺ + OH⁻ + H₂O | 1 | −2 | +2 |
| (13) Lactate⁻ + H₂ → Propionate⁻ + H₂O | 2 | 0 | 0 |

Lactate⁻ = C₃H₆O₃⁻;
Propionate⁻ = C₃H₅O₂⁻;
Acetate⁻ = C₂H₃O₂⁻;
C₂HCl₃ = TCE;
C₂H₂Cl₂ = DCE;
C₂H₃Cl = VC;
C₂H₄ = ethene.
*mol of fermentable substrate (reactions (1)-(4)).

### Alkalinity Balances to Predict the Resulting pH.

The alkalinity balance component of the model calculates groundwater pH and the corresponding buffer requirement. The presently disclosed model builds on the concepts of the model previously described (Robinson et al. 2009), but further includes two unique features. First, the presently disclosed model uses as input the results of the electron balance approach described above, thus incorporating production of biomass. This helps to more accurately predict the net changes in acidity and alkalinity, and thus allows for better pH control. Second, the presently disclosed model incorporates methanogenesis and homoacetogenesis, two reactions that often are prevalent and important when performing bioremediation of large dilute plumes of chlorinated ethenes (Macbeth et al. 2004).

Table 3 shows some of the H₂-consuming reactions that are incorporated into the alkalinity balance spreadsheet and how these reactions affect the net groundwater alkalinity. Fermentation and dechlorination reactions typically produce acid, thus leading to a decrease in groundwater pH. On the other hand, the presence of other electron accepting reactions which are net alkalinity producers (e.g., denitrification and sulfate reduction) and/or consume acidity (e.g., methanogenesis and homoacetogenesis), can mitigate or perhaps counter the pH increase from fermentation and dechlorination.

The unique features of one example of a tool can be highlighted with a simple example. In this example, parameters for sediment mineralogy and abiotic processes are not considered, but these can also be incorporated into the tool, as in Robinson et al. (2009). We consider the scenario of a closed system where the fermentable substrate lactate is fed as the electron donor for reductive dechlorination of 1 mM TCE in groundwater of pH 7 containing 10 mM initial alkalinity as bicarbonate. The relevant chemical reactions are shown in Table 4, including the microorganisms that have been assumed to carry out these reactions and the corresponding fₛ° values.

In the example, the following assumptions are made. First, Dehalococcoides is the only dechlorinating organism. Second, all of the TCE is reduced to ethene (using H₂ produced from lactate fermentation). Third, additional H₂ produced in lactate fermentation is consumed either by homoacetogenesis or methanogenesis. In order to further simplify the scenario, we do not include the role of the weak acid acetate. This is a reasonable assumption if the pH remains above ˜5.7, at which time there is ˜10% acetic acid. Varying the amended lactate concentration, we consider three cases: Case 1 involves no homoacetogenesis or methanogenesis, while in Cases 2 and 3 all of additional hydrogen produced by lactate fermentation is consumed by methanogenesis or homoacetogenesis, respectively. The alkalinity balance encompassing these cases is also in Table 4.

TABLE 4
Alkalinity balance for hypothetical Cases 1-3 presented above.

| Reaction* | fₛ⁰ (Microorganism) | ΔCO₂/mol* | ΔHCO₃⁻/mol* |
|---|---|---|---|
| (1) | 0.18^{a} | +(1 − fₛ⁰) | 0 |
| | (Fermenters) | | |
| (5) + (6) + (7) | 0.10^{a} | +1 | −1 |
| | (Dehalococcoides) | | |
| (8) | 0.05^{a} | −0.25 (1 + fₛ⁰) | 0 |
| | (Hydrogenotrophic | | |
| | methanogens) | | |
| (9) | 0.18^{a} | −0.25 (1 + fₛ⁰) | −0.25 (1 + fₛ⁰) |
| | (Homoacetogens) | | |

^{a}See Table 1.
*Stoichiometric reactions and the compound to which the acid or base is normalized are in Table 3.

Assuming that the ionic strength is unity, the resulting molarities for the three cases is presented in Table 5.

TABLE 5
nmoles/L of donor for the hypothetical Cases 1-3 above.

| Reaction* | Case 1 | Case 2 | Case 3 |
|---|---|---|---|
| (1) | [lactate] | [lactate] | [lactate] |
| (5) + (6) + (7) | (3 mol H₂/ | (3 mol H₂/ | (3 mol H₂/ |
| | mol TCE) * | mol TCE) * | mol TCE) * |
| | (1 mM TCE) | (1 mM TCE) | (1 mM TCE) |
| (8) | 0 | (2 mol H₂/ | |
| | | mol lactate) * | 0 |
| | | [lactate] | |
| (9) | 0 | 0 | (2 mol H₂/ |
| | | | mol lactate) * |
| | | | [lactate] |

The resulting pH is then:

10^{-pKa}=([HCO₃⁻]ᵢₙᵢₜᵢₐₗ+(ΣΔHCO₃⁻)[H⁺]/([CO₂]ᵢₙᵢₜᵢₐₗ+ΣΔCO₂) (2)

where pKₐ=6.3, ([HCO₃⁻]ᵢₙᵢₜᵢₐₗ=10 mM, [CO₂]ᵢₙᵢₜᵢₐₗ=2 mM (since pH=7),

ΣΔCO₂=Σᵢ((ΔCO₂/mol*)ᵢ*nᵢ (3)

ΣΔHCO₃⁻=Σᵢ((ΔHCO₃⁻/mol*)ᵢ*nᵢ (4)

where i is each reaction type (i.e. fermentation, dechlorination, methanogenesis, or homoacetogenesis). The buffer requirement to maintain a pH of 7 can then be calculated.

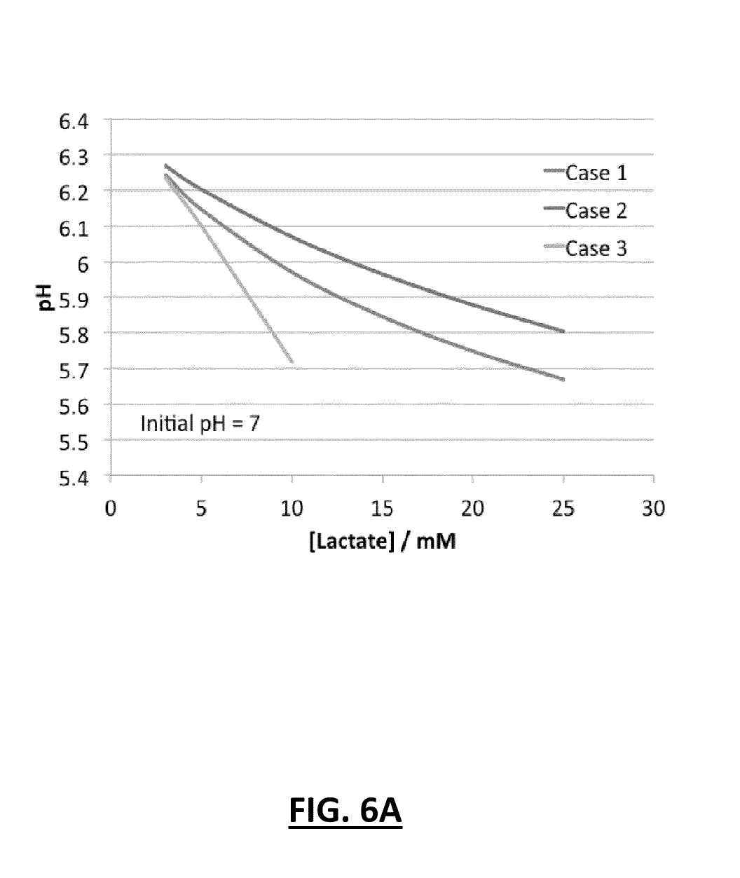

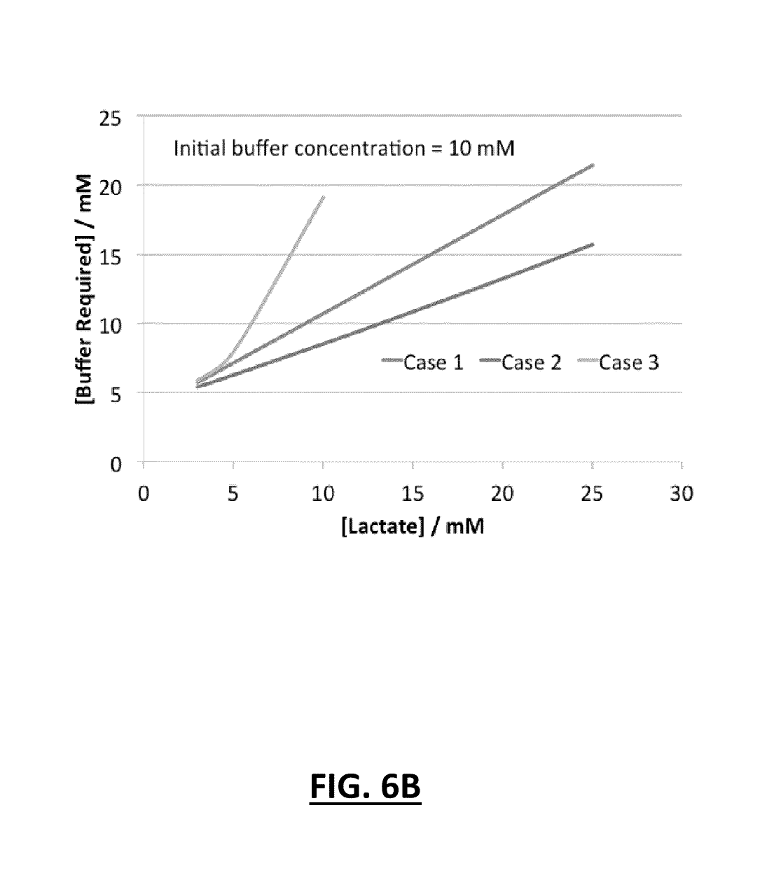

FIG. 6A and FIG. 6B, respectively, show an example (A) groundwater pH as a function of amended lactate concentration, and (B) additional buffer requirement to maintain pH 7 as a function of amended lactate concentration, for hypothetical Cases 1-3 presented above. Case 1: Only dechlorination, Case 2: Dechlorination with hydrogenotrophic methanogenesis, and Case 3: Dechlorination with homoacetogenesis. Concentrations of TCE and initial alkalinity are assumed to be 1 mM and 10 mM (as bicarbonate), respectively, and the initial groundwater pH is assumed to be pH7.

A key observation from this figure is that methanogenesis helps raise the pH by consuming acidity produced from fermentation and dechlorination reactions. On the other hand, although homoacetogenesis consumes acidity, it also consumes alkalinity, thus causing a drop in the pH. This decrease is especially related to limited bicarbonate available, due to our assumption of a closed system. In an open system, dissolution of additional alkalinity due to site mineralogy features may help buffer the system, in which case homoacetogenesis could either not affect the pH or cause an increase in pH. This especially highlights the value of combining electron balance with site mineralogy features, so that accurate predicts of resulting groundwater pH can be made.

The invention has been described herein in considerable detail in order to comply with the Patent Statutes and to provide those skilled in the art with the information needed to apply the novel principles of the present invention, and to construct and use such exemplary and specialized components as are required. However, it is to be understood that the invention may be carried out by different equipment, and devices, and that various modifications, both as to the equipment details and operating procedures, may be accomplished without departing from the true spirit and scope of the present invention.

The references listed below are incorporated by reference.

### REFERENCES

Air Force Center for Environmental Excellence, N. F. E. S. C., Environmental Security Technology Certification Program (2004). Principles and Practices of Enhanced Anaerobic Bioremediation of Chlorinated Solvents.
Aulenta, F., J. M. Gossett, M. P. Papini, S. Rossetti and M. Majone (2005). “Comparative study of methanol, butyrate, and hydrogen as electron donors for long-term dechlorination of tetrachloroethene in mixed anerobic cultures.” Biotechnology and Bioengineering 91(6): 743-753.
Aulenta, F., M. Majone, P. Verbo and V. Tandoi (2002). “Complete dechlorination of tetrachloroethene to ethene in presence of methanogenesis and acetogenesis by an anaerobic sediment microcosm.” Biodegradation 13(6): 411-424.
Azizian, M. F., I. P. G. Marshall, S. Behrens, A. M. Spormann and L. Semprini (2010). “Comparison of lactate, formate, and propionate as hydrogen donors for the reductive dehalogenation of trichloroethene in a continuous-flow column.” Journal of Contaminant Hydrology 113(1-4): 77-92.
Cupples, A. M., A. M. Spormann and P. L. McCarty (2003). “Growth of a Dehalococcoides-like microorganism on vinyl chloride and cis-dichloroethene as electron acceptors as determined by competitive PCR.” Applied and Environmental Microbiology 69(2): 953-959.
Distefano, T. D., J. M. Gossett and S. H. Zinder (1992). “Hydrogen as an electron-donor for dechlorination of tetrachloroethene by an anaerobic mixed culture.” Applied and Environmental Microbiology 58(11): 3622-3629.
Duhamel, M. and E. A. Edwards (2006). “Microbial composition of chlorinated ethene-degrading cultures dominated by Dehalococcoides.” Fems Microbiology Ecology 58(3): 538-549.
Duhamel, M. and E. A. Edwards (2007). “Growth and yields of dechlorinators, acetogens, and methanogens during reductive dechlorination of chlorinated ethenes and dihaloelimination of 1,2-dichloroethane.” Environmental Science & Technology 41(7): 2303-2310.
Duhamel, M., S. D. Wehr, L. Yu, H. Rizvi, D. Seepersad, S. Dworatzek, E. E. Cox and E. A. Edwards (2002). “Comparison of anaerobic dechlorinating enrichment cultures maintained on tetrachloroethene, trichloroethene, cis-dichloroethene and vinyl chloride.” Water Research 36(17): 4193-4202.
He, J., Y. Sung, R. Krajmalnik-Brown, K. M. Ritalahti and F. E. Loffler (2005). “Isolation and characterization of Dehalococcoides sp strain FL2, a trichloroethene (TCE)- and 1,2-dichloroethene-respiring anaerobe.” Environmental Microbiology 7(9): 1442-1450.
He, J. Z., V. F. Holmes, P. K. H. Lee and L. Alvarez-Cohen (2007). “Influence of vitamin B-12 and cocultures on the growth of Dehalococcoides isolates in defined medium.” Applied and Environmental Microbiology 73(9): 2847-2853.
He, J. Z., K. M. Ritalahti, K. L. Yang, S. S. Koenigsberg and F. E. Loffler (2003). “Detoxification of vinyl chloride to ethene coupled to growth of an anaerobic bacterium.” Nature 424(6944): 62-65.
Hendrickson, E. R., J. A. Payne, R. M. Young, M. G. Starr, M. P. Perry, S. Fahnestock, D. E. Ellis and R. C. Ebersole (2002). “Molecular analysis of Dehalococcoides 16S ribosomal DNA from chloroethene-contaminated sites throughout north America and Europe.” Applied and Environmental Microbiology 68(2): 485-495.
Lee, H. S., R. Krajmalnik-Brown, H. Zhang and B. E. Rittmann (2009). “An electron flow model can predict complex redox reactions in mixed-culture fermentative BioH2: Microbial ecology evidence.” Biotechnology and Bioengineering 104(4): 687-697
Lendvay, J. M., F. E. Loffler, M. Dollhopf, M. R. Aiello, G. Daniels, B. Z. Fathepure, M. Gebhard, R. Heine, R. Helton, J. Shi, R. Krajmalnik-Brown, C. L. Major, M. J. Barcelona, E. Petrovskis, R. Hickey, J. M. Tiedje and P. Adriaens (2003). “Bioreactive barriers: A comparison of bioaugmentation and biostimulation for chlorinated solvent remediation.” Environmental Science & Technology 37(7): 1422-1431.
Macbeth, T. W., D. E. Cummings, S. Spring, L. M. Petzke and K. S. Sorenson (2004). “Molecular characterization of a dechlorinating community resulting from in situ biostimulation in a trichloroethene-contaminated deep, fractured basalt aquifer and comparison to a derivative laboratory culture.” Applied and Environmental Microbiology 70(12): 7329-7341.
Madigan, M. T. and J. M. Martinko (2006). Brock Biology of Microorganisms. Upper Saddle River, N.J., Pearson Prentice, Inc.
Major, D. W., M. L. McMaster, E. E. Cox, E. A. Edwards, S. M. Dworatzek, E. R. Hendrickson, M. G. Starr, J. A. Payne and L. W. Buonamici (2002). “Field demonstration of successful bioaugmentation to achieve dechlorination of tetrachloroethene to ethene.” Environmental Science & Technology 36(23): 5106-5116.
Maphosa, F., W. M. de Vos and H. Smidt (2010). “Exploiting the ecogenomics toolbox for environmental diagnostics of organohalide-respiring bacteria.” Trends in Biotechnology 28(6): 308-316.
Maymo-Gatell, X., Y. T. Chien, J. M. Gossett and S. H. Zinder (1997). “Isolation of a bacterium that reductively dechlorinates tetrachoroethene to ethene.” Science 276(1568-1571).
Maymo-Gatell, X., V. Tandoi, J. M. Gossett and S. H. Zinder (1995). “Characterization of an H₂-utilizing enrichment culture that reductively dechlorinates tetrachloroethene to vinyl-chloride and ethene in the absence of methanogenesis and acetogenesis.” Applied and Environmental Microbiology 61(11): 3928-3933.
McCarty, P. L., M. Y. Chu and P. K. Kitanidis (2007). “Electron donor and pH relationships for biologically enhanced dissolution of chlorinated solvent DNAPL in groundwater.” European Journal of Soil Biology 43(5-6): 276-282.
Müller, J. A., B. M. Rosner, G. von Abendroth, G. Meshulam-Simon, P. L. McCarty and A. M. Spormann (2004). “Molecular identification of the catabolic vinyl chloride reductase from Dehalococcoides sp strain VS and its environmental distribution.” Applied and Environmental Microbiology 70(8): 4880-4888.
Parameswaran, P., C. I. Torres, H. S. Lee, R. Krajmalnik-Brown and B. E. Rittmann (2009). “Syntrophic interactions among anode respiring bacteria (ARB) and non-ARB in a biofilm anode: Electron balances.” Biotechnology and Bioengineering 103(3): 513-523.
Parameswaran, P., H. S. Zhang, C. I. Torres, B. E. Rittmann and R. Krajmalnik-Brown (2010). “Microbial community structure in a biofilm anode fed with a fermentable substrate: The significance of hydrogen scavengers.” Biotechnology and Bioengineering 105(1): 69-78.
Richardson, R. E., V. K. Bhupathiraju, D. L. Song, T. A. Goulet and L. Alvarez-Cohen (2002). “Phylogenetic characterization of microbial communities that reductively dechlorinate TCE based upon a combination of molecular techniques.” Environmental Science & Technology 36(12): 2652-2662.
Ritalahti, K. M., B. K. Amos, Y. Sung, Q. Z. Wu, S. S. Koenigsberg and F. E. Loffler (2006). “Quantitative PCR targeting 16S rRNA and reductive dehalogenase genes simultaneously monitors multiple Dehalococcoides strains.” Applied and Environmental Microbiology 72(4): 2765-2774.
Rittmann, B. E. and P. L. McCarty (2001). Environmental Biotechnology: Principles and Applications. New York, McGraw-Hill Book Co.
Robinson, C., D. A. Barry, P. L. McCarty, J. I. Gerhard and I. Kouznetsova (2009). “pH control for enhanced reductive bioremediation of chlorinated solvent source zones.” Science of the Total Environment 407(16): 4560-4573.
Seeliger, S., P. H. Janssen and B. Schink (2002). “Energetics and kinetics of lactate fermentation to acetate and propionate via methylmalonyl-CoA or acrylyl-CoA.” Fems Microbiology Letters 211(1): 65-70.
Smidt, H. and W. M. de Vos (2004). “Anaerobic microbial dehalogenation.” Annual Review of Microbiology 58: 43-73.
Sung, Y., K. F. Fletcher, K. M. Ritalaliti, R. P. Apkarian, N. Ramos-Hernandez, R. A. Sanford, N. M. Mesbah and F. E. Loffler (2006a). “Geobacter lovleyi sp nov strain SZ, a novel metal-reducing and tetrachloroethene-dechlorinating bacterium.” Applied and Environmental Microbiology 72(4): 2775-2782.
Sung, Y., K. M. Ritalahti, R. P. Apkarian and F. E. Loffler (2006b). “Quantitative PCR confirms purity of strain GT, a novel trichloroethene-to-ethene-respiring Dehalococcoides isolate.” Applied and Environmental Microbiology 72(3): 1980-1987.
Tang, Y. J. J., S. Yi, W. Q. Zhuang, S. H. Zinder, J. D. Keasling and L. Alvarez-Cohen (2009). “Investigation of Carbon Metabolism in “Dehalococcoides ethenogenes” Strain 195 by Use of Isotopomer and Transcriptomic Analyses.” Journal of Bacteriology 191(16): 5224-5231.
Vainberg, S., C. W. Condee and R. J. Steffan (2009). “Large-scale production of bacterial consortia for remediation of chlorinated solvent-contaminated groundwater.” Journal of Industrial Microbiology & Biotechnology 36(9): 1189-1197.
Ziv-El, M., A. G. Delgado, Y. Yao, D. W. Kang, K. G. Nelson, R. U. Halden and R. Krajmalnik-Brown (2011). “Development and characterization of DehaloR̂2, a novel anaerobic microbial consortium performing rapid dechlorination of TCE to ethene.” Applied Microbiology and Biotechnology 92(5): 1063-1071.
Ziv-El, M., S. C. Popat, P. Parameswaran, D. W. Kang, A. Polasko, R. U. Halden, B. E. Rittmann and R. Krajmalnik-Brown (2012). “Using electron balances and molecular techniques to assess trichloroethene-induced shifts to a dechlorinating microbial community.” Biotechnology and Bioengineering In Press.

What is claimed is:

1. A computer-implemented method that serves as a prediction and assessment tool for bioremediation performance comprising:
operating a processor to accept input data including chemical data and microbial data;
operating the processor to integrate the chemical data and microbial data with electron and alkalinity balances using microorganism-specific parameters including,
a plurality of fractions of donor electrons that each group of microorganisms use for biomass synthesis (fₛ°),
a plurality of corresponding true yields (Y) expressed in electron equivalents, and
a plurality of microorganism cell volumes; and
operating the processor to calculate the relative abundance of each microorganism group as generated from the microorganism-specific parameters and to calculate the resulting alkalinity and pH.

2. The method of claim 1 wherein the chemical data inputs are selected from the group consisting of electron acceptors at a contaminated site and the fermentable substrate to be used as the electron donor, the end or intermediate products of the reactions, or combinations thereof.

3. The method of claim 1 wherein the microbial data comprise microorganisms that are expected to be involved in the flow of electron donor to reductive dechlorination, reduction of the other electron acceptors, and fermentation.

4. The method of claim 1 wherein chemical inputs of a type 1 are the electron acceptors at a contaminated site and the fermentable substrate to be used as the electron donor, wherein the chemical inputs of type 1 are applicable for use of the model as a predictive tool.

5. The method of claim 1 wherein chemical inputs of type 2 are the end (or intermediate) products of the reactions, as would be the case when the model is to be used for assessment of the bioremediation processes that already occurred at a site.

6. The method of claim 1 wherein the chemical inputs comprise a combination of type 1 and type 2 chemical inputs.

7. The method of claim 1 wherein a second type of input comprises dominant microorganisms that are expected to be involved in the flow of electron donor to reductive dechlorination, reduction of the other electron acceptors, and fermentation.

8. The method of claim 1 wherein the relative abundance of each microorganism group, i, is computed assuming cells to be N % dry weight by mass, with dry weight M % organic by mass, where M and N represent real numbers:
$${microorganism}_{i} [ \frac{cell copies}{L} ] = \frac{\begin{matrix}{biomass}_{i} [ \frac{{e}^{-} eq .}{L} ] \times \\ {Yield}_{i} [ \frac{g dry org . bio .}{{e}^{-} eq .} ] \times {10}^{12} [ \frac{{µm}^{3}}{g bio .} ]\end{matrix}}{\begin{matrix}{f}_{s , i}^{0} \times N \% [ dry cell fraction ] \times \\ M \% [ org . cell fraction ] \times volume {cell}_{i} [ {µm}^{3} ]\end{matrix}}$$

9. The method of claim 1 further comprising operating a processor to implement a software program that allows entry of numerical values or data into the rows or columns of a spreadsheet, and to use these numerical entries including calculations, graphs, statistical analysis, experimental inputs, a first table of microorganism features, a second table of electron-balance components based on electron flow and a set of output tables calculated from the first and second tables.

10. The method of claim 9 wherein the first table comprises a set of volume measurements, a set of yield values, and a set of fractions of donor electrons that each microorganism sends to biomass synthesis (fₛ°).

11. The method of claim 9 wherein the set of output tables comprise the relative abundance of each microorganism group, i, computed assuming cells to be N % dry weight by mass, with dry weight M % organic by mass, where M and N represent real numbers:
$${microorganism}_{i} [ \frac{cell copies}{L} ] = \frac{\begin{matrix}{biomass}_{i} [ \frac{{e}^{-} eq .}{L} ] \times \\ {Yield}_{i} [ \frac{g dry org . bio .}{{e}^{-} eq .} ] \times {10}^{12} [ \frac{{µm}^{3}}{g bio .} ]\end{matrix}}{\begin{matrix}{f}_{s , i}^{0} \times N \% [ dry cell fraction ] \times \\ M \% [ org . cell fraction ] \times volume {cell}_{i} [ {µm}^{3} ]\end{matrix}}$$

12. A computer-readable medium encoded with a computer program for implementing a prediction and assessment tool for bioremediation performance comprising:
means for operating a processor to accept input data including chemical data and microbial data;
means for operating the processor to integrate the chemical data and microbial data with electron and alkalinity balances using microorganism-specific parameters including,
a plurality of fractions of donor electrons that each microorganism sends to biomass synthesis (fₛ°),
a plurality of corresponding true yields (Y) expressed in electron equivalents, and
a plurality of microorganism cell volumes; and
means for operating the processor to calculate the relative abundance of each microorganism group as generated from the microorganism-specific parameters and to calculate the resulting alkalinity and pH.

13. The computer-readable medium of claim 12 wherein the chemical data inputs are selected from the group consisting of electron acceptors at a contaminated site and the fermentable substrate to be used as the electron donor, the end or intermediate products of the reactions, and combinations thereof.

14. The computer-readable medium of claim 12 wherein the microbial data comprises microorganisms that are expected to be involved in the flow of electron donor to reductive dechlorination, reduction of the other electron acceptors, and fermentation.

15. The computer-readable medium of claim 12 wherein chemical inputs of a type 1 are the electron acceptors at a contaminated site and the fermentable substrate to be used as the electron donor, wherein the chemical inputs of type 1 are applicable for use of the model as a predictive tool.

16. The computer-readable medium of claim 12 wherein chemical inputs of type 2 are the end (or intermediate) products of the reactions, as would be the case when the model is to be used for assessment of the bioremediation processes that already occurred at a site.

17. The computer-readable medium of claim 12 wherein the chemical inputs comprise a combination of type 1 and type 2 chemical inputs.

18. The computer-readable medium of claim 12 wherein a second type of input comprises dominant microorganisms that are expected to be involved in the flow of electron donor to reductive dechlorination, reduction of the other electron acceptors, and fermentation.

19. The computer-readable medium of claim 1 wherein the relative abundance of each microorganism group, i, is computed assuming cells to be N % dry weight by mass, with dry weight M % organic by mass, where M and N represent real numbers:
$${microorganism}_{i} [ \frac{cell copies}{L} ] = \frac{\begin{matrix}{biomass}_{i} [ \frac{{e}^{-} eq .}{L} ] \times \\ {Yield}_{i} [ \frac{g dry org . bio .}{{e}^{-} eq .} ] \times {10}^{12} [ \frac{{µm}^{3}}{g bio .} ]\end{matrix}}{\begin{matrix}{f}_{s , i}^{0} \times N \% [ dry cell fraction ] \times \\ M \% [ org . cell fraction ] \times volume {cell}_{i} [ {µm}^{3} ]\end{matrix}}$$

20. The computer-readable medium of claim 12 further comprising operating a processor to implement a software program that allows entry of numerical values or data into the rows or columns of a spreadsheet, and to use these numerical entries including calculations, graphs, statistical analysis, experimental inputs, a first table of microorganism features, a second table of electron-balance components based on electron flow and a set of output tables calculated from the first and second tables.

21. The computer-readable medium of claim 20 wherein the first table comprises a set of volume measurements, a set of yield values and a set of fractions of donor electrons that each microorganism sends to biomass synthesis (fₛ°).

22. The computer-readable medium of claim 20 wherein the a set of output tables comprise the relative abundance of each microorganism group, i, computed assuming cells to be N % dry weight by mass, with dry weight M % organic by mass, where M and N represent real numbers:
